(19) United States
(12) Patent Application Publication
(10) Pub. No.: US 2007/0201833 A1
(43) Pub. Date: Aug. 30, 2007

(54) Interface for defining aperture

(75) Inventors: Timothy David Cherna, San Francisco, CA (US); John Samuel Bushell, San Jose, CA (US); Sean Matthew Gies, San Francisco, CA (US)

Correspondence Address: HICKMAN PALERMO TROUNG & BECKER LLP;AND APPLE INC., 2055 GATEWAY PLACE, SUITE 550, SAN JOSE, CA, 95110-1089, US

(73) Assignee: Apple Inc.

(21) Appl. No.: 11/707,734

(22) Filed: Feb. 16, 2007

Related U.S. Application Data
(60) Provisional application No. 60/774,490, filed on Feb. 17, 2006.

(51) Int. Cl. H04N 7/00; H04N 5/91

(52) U.S. Cl. 386/95

(57) ABSTRACT

Techniques are described for creating and storing data describing a pixel aspect ratio and specifications of the clean aperture of video data. This data may be used to determine parameters of one or more modes of display which may be selected for an individual track based upon the rendering intent, and the parameters may be stored with the video data.

### RELATED APPLICATION DATA

This application is related to and claims the benefit of priority from provisional U.S. Application Ser. No. 60/774,490, entitled “Interface for Defining Aperture,” filed Feb. 17, 2006 (Attorney Docket Number 60108-0113), the entire disclosure of which is incorporated by reference as if fully set forth herein, under 35 U.S.C. §119(e).

### FIELD OF THE INVENTION

The present invention relates to video data and, more specifically, to an approach for describing and utilizing properties related to the accurate display of video data.

### BACKGROUND

Video data is comprised of frames and may be organized in terms of “tracks,” which are portions of video data that together may be represented in the metaphor of a “movie.” A movie may be comprised of one or several tracks, each track comprised of multiple frames. Examples include QuickTime™ movies and movie objects from Apple Computer, Cupertino, Calif.

A movie may also contain metadata indicating the dimensions of tracks and the geometric relationship between the tracks. For example, a subtitle track's position might be above, below or overlapping with a video track; one video track may be displayed smaller and overlapping another video track in a “picture-in-picture” layout.

Video signals are captured from an input device, such as a digital camera, and the signals are transformed into digital video data. The capture and display of video data is measured in pixels, which are the smallest part of a digitized image. Pixels are used in measuring image size and resolution, i.e., 640 pixels by (×) 480 pixels is the pixel resolution of most VGA Monitors. A high-definition television (HDTV) may display 1920 pixels×1080 pixels.

These measurements of a display define a picture aspect ratio, which is the ratio of the width of the image to the height of the image. For most television images the picture aspect ratio is 4:3, the NTSC standard. HDTV uses a picture aspect ratio of 16:9. Some video display and encoding systems sample images with different horizontal and vertical spacing between pixels. The ratio between the horizontal and vertical sampling rate determines the pixel aspect ratio. For example, most computer screens have square pixels, which is to say that they have a pixel aspect ratio of 1:1. NTSC video signals have a pixel aspect ratio of 10:11.

A common need with regard to video data is maintaining consistency of geometric shapes, such as a circle. For example, when a geometric element like a circle is displayed on displays with differing pixel aspect ratios, adjustments need to be made so that the circle does not appear as an ellipse or other shape. Images of other objects would be similarly distorted.

A current approach to correcting video display for non-square pixels is to take the image size and scale it to the picture size. For example, to display NTSC video on a computer display one could take the 720×480 image and scale it to 640×480, which is a 4:3 ratio in order to correct the geometry. A drawback to this approach is that it fails to account for the notion of clean aperture.

The clean aperture is the region of video that is clean of transition artifacts due to the encoding of the signal. It is the region of video that should be displayed to viewers and may be considered a subset of the full video display, usually a rectangular portion lying completely inside the picture area. The portion of the image outside the clean aperture is called the edge processing region. The edge processing region may contain artifacts. This is because the video information in the edge processing region is not as reliable as the remainder of the data, because the edge processing region represents a transition from no data to data. The clean aperture excludes this edge processing region so that artifacts and “junk” in the signal are not presented to the user.

Because current approaches do not maintain the notion of a clean aperture while correcting for pixel aspect ratio differences, the integrity of the image is not maintained and the position of the clean aperture is often inaccurately calculated. The previous approaches overcorrect for pixel aspect ratio differences, which leads to inaccurate display of geometric images and the compounding of errors where multiple stages of processing are utilized on video data.

Other current approaches include rendering the video incorporating cropping to the clean aperture and scaling to compensate for pixel aspect ratio differences. They may include further compressing the rendered video. Such approaches are inflexible, because they don't account for the variety of rendering intents. Content that has been prepared for viewing in these ways is a poor choice for processing, as image data has been lost. Content prepared for authoring or processing is not well prepared for viewing, as the edge processing region has not been cropped and the pixel aspect ratio may not have been corrected

Therefore, an approach that allows for scaling the clean aperture of video data to a desired size while maintaining correct dimensions and accurate geometry, which does not experience the disadvantages of the above approaches, is desirable. The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of an embodiment illustrating the display of video data in a mode where the existing track dimensions are maintained;

FIG. 2 is a block diagram of an embodiment illustrating the display of video data in a mode where the video data is cropped to the clean aperture and scaled according to the pixel aspect ratio to compensate for the display aspect ratio;

FIG. 3 is a block diagram of an embodiment illustrating the display of video data in a mode where the video data is not cropped to the clean aperture, but the video data is scaled to the correct pixel aspect ratio;

FIG. 4 is a block diagram of an embodiment illustrating a user interface element allowing for the selection of aperture modes;

FIG. 5 is a flowchart illustrating the functional steps of displaying video data according to an embodiment of the invention;

FIG. 6 is a flowchart illustrating the functional steps of displaying video data according to an embodiment of the invention;

FIG. 7 is a flowchart illustrating the functional steps of displaying video data according to an embodiment of the invention;

FIG. 8 is a flowchart illustrating the functional steps of displaying video data according to an embodiment of the invention; and

FIG. 9 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

Techniques are described for creating and storing data describing a pixel aspect ratio and specifications of the clean aperture of video data. This data may be used to determine parameters of one or more modes of display which may be selected for an individual track based upon the rendering intent, and the parameters may be stored with the video data.

According to an embodiment, encoded video data is acquired; for example, from a digital video camera or from a file containing video data. A first set of data describing the pixel aspect ratio of the video data is created and/or stored. A second set of data describing the specifications of a clean aperture of the video data is created and/or stored. The first and second sets of data describing the pixel aspect ratio of the video data and the data describing the clean aperture of the video data are associated with the video data; for example, as metadata stored in the same file as the video data. The data may be associated with an entire file comprising the video data, one or more individual frames of the video data, or one or more tracks of the video data. Based on the first and second data, the video data is displayed in a particular mode of a plurality of modes after one or more non-destructive operations are performed on the video data.

According to an embodiment, encoded video data is acquired; for example, from a digital video camera or from a file containing video data. A first set of data describing the pixel aspect ratio of the video data is created and/or stored. A second set of data describing the specifications of a clean aperture of the video data is created and/or stored. Based at least in part on the first and second sets of data, a third set of data is created and stored that describes properties of each mode of a plurality of display modes for the video data. The first, second, and third sets of data are associated with the video data; for example, as metadata stored in the same file as the video data. The data may be associated with an entire file comprising the video data, one or more individual frames of the video data, or one or more tracks of the video data. The first, second, and third sets of data are stored within the same file as the video data.

According to an embodiment, encoded video data is received. A first set of data describing the pixel aspect ratio of the video data is associated with the video data; for example, as metadata. A second set of data describing the specifications of a clean aperture of the video data is associated with the video data; for example, as metadata. The dimensions of the video data are determined. A first and second set of properties of the video data are calculated based at least in part on analyzing the first and second sets of data. For example, the properties may include the dimensions of the video data compensating for cropping the video data to the clean aperture and scaling the cropped video data by the ratio between the pixel aspect ratio of the video data and an output pixel aspect ratio of an intended display. The properties may include the dimensions of the video data compensating for cropping the video data to the clean aperture and scaling the cropped video data by the ratio between the pixel aspect ratio of the cropped video data to square pixels, for example a 1:1 ratio. Metadata is created and associated with the video data, where the metadata describes the dimensions of the video data, the first set of properties, and the second set of properties. The metadata is stored within the same file as the video data.

According to an embodiment, a first set of data describing the pixel aspect ratio of the video data is associated with the video data; for example, as metadata. A second set of data describing the specifications of a clean aperture of the video data is created and/or stored; for example, as metadata. The first and second sets of data describing the pixel aspect ratio of the video data and the data describing the clean aperture of the video data are associated with the video data; for example, as metadata stored in the same file as the video data. The data may be associated with an entire file comprising the video data, one or more individual frames of the video data, or one or more tracks of the video data. User input is received selecting a particular display mode of a plurality of display modes. Each of the modes is associated with data describing at least the dimensions of the video based upon at least the first and second sets of data. For example, based on the pixel aspect ratio of a portion of video data, as well as the specifications of a clean aperture region of the video data, data may be calculated describing certain parameters of the display of the video data. For example, if the video data is cropped to the clean aperture and then scaled to the ratio between the pixel aspect ratio and the output pixel aspect ratio, data describing parameters of displaying the video data, such as the display dimensions and placement, may be associated with a “mode.” In response to the user input selecting the mode, a third set of data is calculated that describes placement of the display of the video data by applying a geometric transformation to the data associated with the selected mode. The video data is displayed.

### Interface for Defining Aperture

According to an embodiment, information describing dimensions of video data is generated and associated with the video data. This information may consist of key-value pairs and the information allows the application to correct for clean aperture and aspect ratio. According to an embodiment, the information allows for the creation and selection of differing “modes” of display where the video data may be processed in one or more ways, examples being: cropped to the clean aperture, scaled to the correct pixel aspect ratio, or maintained at an original dimension. These may be called aperture modes.

According to an embodiment, video data is often structured as a movie, which is one or more video tracks comprised of video data. Previously, each track had a single track dimension associated with the video data that specified how big the track would be on the display. The individual images (frames) comprising the track were then rendered to the scale of the track and to the specified dimensions. Applications that consume the video data; for example, playing back the video data, would analyze the track dimensions and change the display accordingly. According to an embodiment, one mode contemplated by the disclosed approaches maintains compatibility with this previous behavior. Applications using this mode would have to determine to what dimensions to scale the track based on a current rendering intent, whether it be processing or end-user viewing.

According to an embodiment, data describing a pixel aspect ratio of a track and specifications of the clean aperture are created and maintained with the new video content, and previously-existing video content may be analyzed and the data as described above created and stored with the content, whether the data is associated with each frame of the video data or the entire track or movie. This data is associated with one or more predetermined modes of display, which may be selected for an individual track based upon the rendering intent. Instead of the application determining these properties and clean aperture information independently, the data is provided to the application along with the video data. For example, the rendering engine of an application could use a mode that displays every pixel at the correct aspect ratio, thereby leaving the edge processing region viewable during processing and editing, while a viewing engine could use a mode that crops the video data to the clean aperture and scales the result to the appropriate aspect ratio, thereby maintaining geometric accuracy.

According to an embodiment, by providing data that describes dimensions and properties of video data, such as the dimensions and placement of the clean aperture and the pixel aspect ratio, and keeping this data separate from other geometric transformation of video data, user-specified operations may be performed on video data without interfering with correction operations. For example, an application may scale video data to 50% of its original size, expand it to 200% of its original size, rotate the track, resize a window, or create a composite of several video tracks without needing to be concerned with the details of pixel aspect ratios and clean apertures.

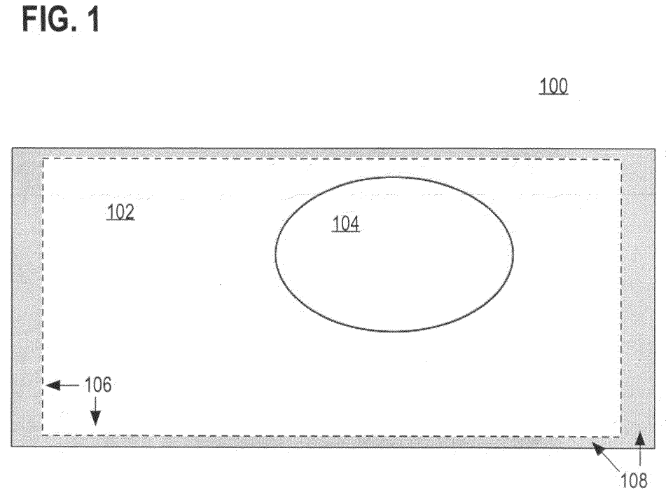

FIG. 1 is a block diagram 100 of an embodiment illustrating the display of video data 102 in a mode where the existing track dimensions are maintained. The 720×480 non-square pixels are being displayed without correction as 720×480 square pixels, resulting in the 4:3 picture being stretched horizontally. The circle 104 is therefore displayed as a wide ellipse. The borders designated by the dotted lines 106 represent the clean aperture boundary and the area between the outside boundary of the clean aperture and the inside of the track boundary indicates the edge processing region 108.

The video data displayed in the mode illustrated in FIG. 1 generally represents the image that a camera would be recording. A user desiring to process the raw pixels of video data would process in this mode because the video data has not been scaled, and the display is showing every pixel.

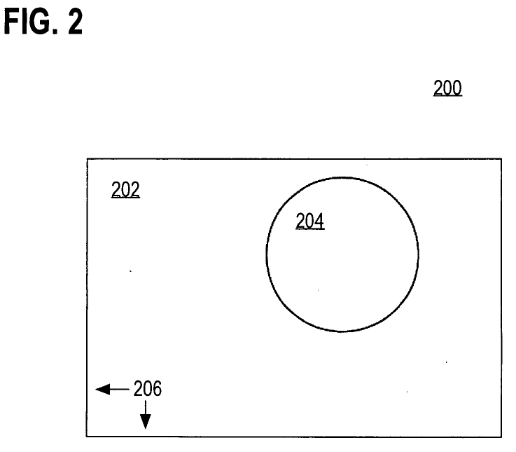

FIG. 2 is a block diagram 200 of an embodiment illustrating the display of video data 202 in a mode where the video data is cropped to the clean aperture and scaled according to the pixel aspect ratio to compensate for the display aspect ratio. The central 704×480 non-square pixels constitute the clean aperture. They are scaled and displayed as 640×480 square pixels, preserving the correct 4:3 picture aspect ratio. This results in the circle 204 being geometrically accurate. The borders designated by the lines 206 represent the clean aperture boundary, which in this mode comprises the entire displayed area. The edge processing region has been cropped prior to scaling the video data.

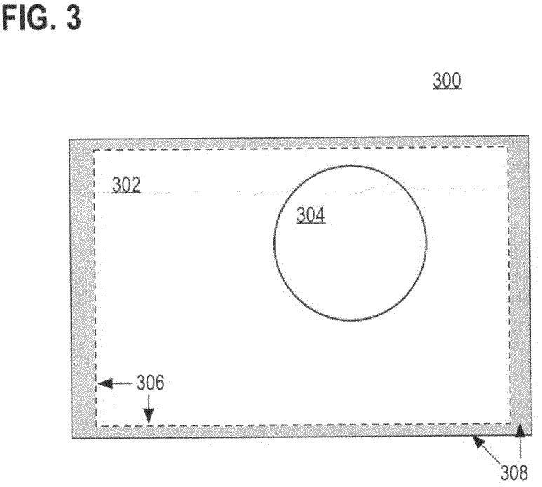

FIG. 3 is a block diagram 300 of an embodiment illustrating the display of video data 302 in a mode where the video data is not cropped to the clean aperture, but the video data is scaled to the correct pixel aspect ratio. The 720×480 non-square pixels are scaled to 654×480 square pixels, correctly compensating for the difference in pixel aspect ratio. This results in the circle 304 being geometrically accurate. The borders designated by the dotted lines 306 represent the clean aperture boundary and the area between the outside boundary of the clean aperture and the inside of the track boundary indicates the edge processing region 308. In this case the resulting image has a picture aspect ratio wider than 4:3 because it includes the edge processing region. This mode is appropriate for users that are working with the video data and desire to see all the pixels of the image, even those in the edge processing region, but at the correct pixel aspect ratio.

According to an embodiment, data describing dimensions and properties of video data is associated with the video data, and specified modes, as described above, may be selected for video data based upon the data. One example is data describing the pixel aspect ratio of the video data. For square pixel NTSC video, the data may comprise two numbers, such as 1 and 1, as the horizontal and vertical spacing of the pixels that comprise the video data, in this case describing a square pixel. For non-square pixel NTSC video, the data may indicate 10 and 11 as the horizontal and vertical spacing of the pixels that comprise the video data. Another example is the specification of the clean aperture rectangle. The data may comprise dimensions in pixels, such as 704 and 480, along with numbers indicating how the clean aperture is positioned in the overall display. This data is calculated to provide the dimensions for displaying the video data depending on the selected mode. For example, the data is analyzed to calculate what the dimensions would be for a mode where the video data is cropped to the clean aperture and scaled according to the pixel aspect ratio to compensate for the display aspect ratio, and the calculated dimensions are associated with the track. The data is then analyzed to calculate dimensions for other available modes, such as a mode where the video data is not cropped to the clean aperture, but the video data is scaled to the correct pixel aspect ratio. These calculated dimensions are also associated with the track. The software responsible for displaying the movie may then determine where the video track is going to be positioned depending on the selected mode. By performing the calculations at the track layer, the data may be propagated to the movie layer and relieve the movie layer of the need to perform these calculations.

In one embodiment, the data describing the dimensions and properties of the video data comprises metadata that is stored in one or more locations. The metadata may be encoded and stored in the video data file, describing the geometric description of the movie or track, as well as being stored with and/or associated with each individual frame of video data. According to an embodiment, this metadata is in a key-value pair format. In an embodiment, files comprised of video data have a header that describes the video data. This header may be structured as atoms, each of which consists of a length code and a 4 byte ID code followed by data. Atoms are associated with the video data and describe various properties of the video data. The metadata described above may take the form of atoms associated with the video data.

This metadata describes the various modes of display that may be selected and generated based on the pixel aspect ratio of the selected video data and the dimensions and placement of the clean aperture. By calculating these values, the dimensions of the available modes may be determined and made available to applications through the metadata. When new video content is created, the properties of the new content are used to calculate and create the metadata. Video content that does not have this metadata associated with it may be analyzed and the metadata created for the content. According to an embodiment, this analyzing does not change the original method of reading data from the movies, thereby assuring backwards compatibility and allowing additional features, such as the modes, to be provided with older content.

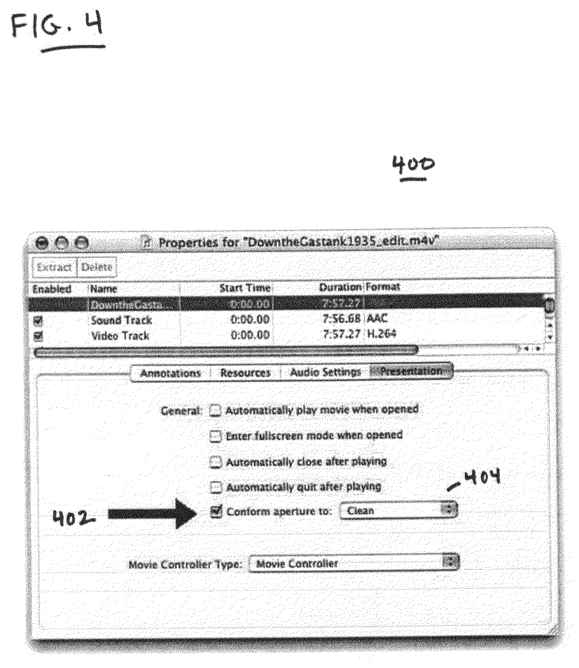

FIG. 4 is a block diagram 400 of an embodiment illustrating a user interface element allowing for the selection of aperture modes. According to an embodiment, metadata associated with video data describing various aperture modes is made available to applications that display the video data. A conform aperture setting 402 is displayed that allows a user to analyze older content and create this metadata. A drop-down menu interface element 404 is used to choose from one of several available modes based on the metadata. Examples of available modes may be “classic,” where the aperture is displayed according to the dimensions as specified by the track itself. “Clean aperture” mode crops the video to the clean aperture described by the metadata and scales the video according to the pixel aspect ratio of the track, also described by the metadata. “Production aperture” mode scales the video according to the pixel aspect ratio but does not crop the video. “Encoded pixels aperture” mode does not perform any cropping or scaling of the video.

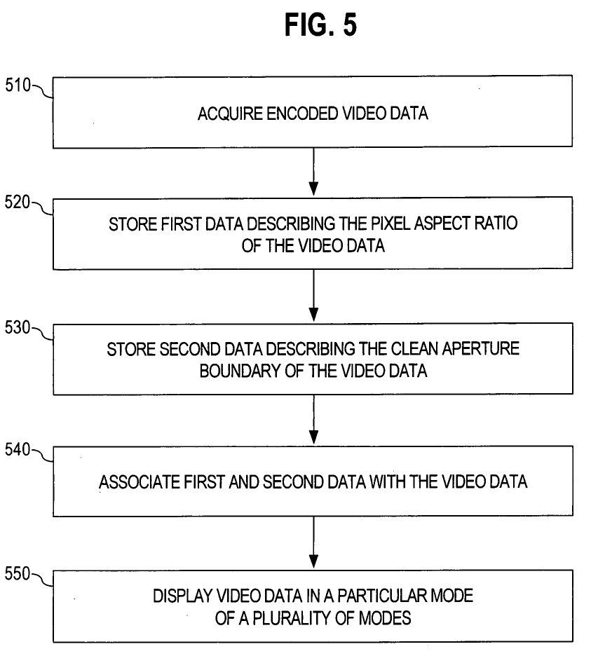

FIG. 5 is a flowchart illustrating the functional steps of displaying video data according to an embodiment of the invention. The particular sequence of steps illustrated in FIG. 5 is merely illustrative for purposes of providing a clear explanation. Other embodiments of the invention may perform various steps of FIG. 5 in parallel or in a different order than that depicted in FIG. 5.

In step 510, encoded video data is acquired; for example, from a digital video camera or from a file containing video data. In step 520, a first set of data describing the pixel aspect ratio of the video data is created and/or stored. In one embodiment, this data may comprise two numbers, such as 1 and 1, as the horizontal and vertical spacing of the pixels that comprise the video data, in this case describing a square pixel. For non-square pixel NTSC video, the data may indicate 10 and 11 as the horizontal and vertical spacing of the pixels that comprise the video data. The pixel aspect ratio may be determined in several ways; for example, by analyzing the video data or by reading metadata associated with the video data that describes the pixel aspect ratio. Additionally, data describing the pixel aspect ratio may be entered, for example by inputting numbers from a keyboard.

In step 530, a second set of data describing the specifications of a clean aperture of the video data is created and/or stored. Because the clean aperture is the region of video that is clean of transition artifacts due to the encoding of the signal and is the region of video that is desired to be displayed to viewers, the parameters defining the outline of the clean aperture may be described as a boundary between “desired” and “undesired” data, as opposed to the data itself. The portion of the image outside the clean aperture is called the edge processing region and the video data in that location represents the “undesired” data. The specifications may include the dimensions of the clean aperture in pixels, such as 704 and 480, along with numbers indicating how the clean aperture is placed or positioned in the overall display. The numbers may be in the form of X and Y coordinates in pixels for one or more points along the clean aperture boundary, such as all four corners.

In step 540, the first and second sets of data describing the pixel aspect ratio of the video data and the data describing the clean aperture of the video data are associated with the video data; for example, as metadata stored in the same file as the video data. The data may be associated with an entire file comprising the video data, one or more individual frames of the video data, or one or more tracks of the video data. In one embodiment, the data describing the pixel aspect ratio of the video data and the data describing the clean aperture of the video data is comprised of key-value pairs.

In step 550, based on the first and second data, the video data is displayed in a particular mode of a plurality of modes. According to an embodiment, the dimensions defining the display properties of the modes are predetermined. Certain operations may use the values defined by the first and second sets of data and have to be performed on the video data in order to display the video data in the particular mode selected. For example, one of the display modes may require that the video data be cropped to the boundary described by the first set of data, then scaling the cropped video data by the ratio between the pixel aspect ratio of the video data as described by the first set of data and an output pixel aspect ratio, and then displaying the video data. According to an embodiment, the output pixel aspect ratio is the pixel aspect ratio of the intended display and is related to and/or defined by the picture size and picture aspect ratio of the output display; for example, a high definition television may have a picture size of 1920×1080 and picture aspect ratio of 16:9, while a computer monitor may have a picture size 800×600 and pixel aspect ratio of 4:3, both resulting in 1:1 pixel aspect ratios.

Another one of the modes may require that the video data be scaled by the ratio between the between the pixel aspect ratio of the video data as described by the first set of data and an output pixel aspect ratio, and then displaying the video data. Another mode may use the original dimensions and parameters of the video data with no cropping or scaling.

According to an embodiment, the particular mode is selected in response to user input. For example, a graphical user interface element such as a drop-down listing of all available modes may be provided, and by selecting one of the modes in the list, the video data will be displayed in the selected mode.

According to an embodiment, performing the operations, such as scaling and cropping, do not permanently alter the video data, as the changes are for display only. The entirety of the video data is maintained, as a user may desire to switch from one mode to another during a single viewing; for example, while editing video data, a user may want to see the edge processing region but have the video data scaled to the correct pixel aspect ratio, and after performing an editing task, switch to a mode where the video data is cropped to the clean aperture and scaled.

According to an embodiment, the video data may not have associated with it a first set of data describing the pixel aspect ratio of the video data and second set of data describing the specifications of clean aperture of the video data. For example, video data that was created or edited on systems incompatible with the storing and/or associating of metadata with the video data. In this case, the video data may be analyzed and the properties of the video data upon which the first and second sets of video data are based may be determined and then associated with the video data. In an embodiment, the analyzing does not change the original video data other than to perhaps add the metadata. The ability to read and/or view the original video data is preserved.

According to an embodiment, additional parameters of the video data are envisioned as being described by metadata that is associated with the video data and then used at least in part to determine a mode of displaying the video data. The types and specification of metadata is not limited to the described embodiment, and additional modes based upon this metadata are envisioned as being provided.

In an embodiment, the first and second sets of data, as well as any other data that may be associated with the video data, are used in calculations that result in data describing properties of each available mode; for example, data describing the dimensions for displaying the video data depending on the selected mode. For example, the data is analyzed to calculate what the dimensions would be for the mode where the video data is cropped to the clean aperture and scaled according to the pixel aspect ratio to compensate for the display aspect ratio, and the properties of the mode, such as the dimensions, are associated with the video data. The data may be associated with individual frames or tracks of video as well. The data is then analyzed to calculate properties for other available modes, such as a mode where the video data is not cropped to the clean aperture, but the video data is scaled to the correct pixel aspect ratio. According to an embodiment, these properties are described by metadata that is associated with the video data, which may be stored in the same file as the video data.

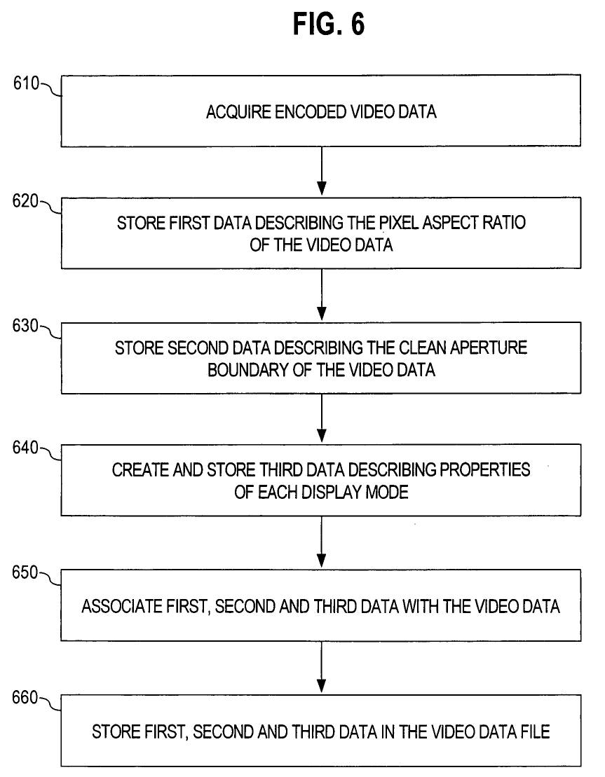

FIG. 6 is a flowchart illustrating the functional steps of displaying video data according to an embodiment of the invention. The particular sequence of steps illustrated in FIG. 6 is merely illustrative for purposes of providing a clear explanation. Other embodiments of the invention may perform various steps of FIG. 6 in parallel or in a different order than that depicted in FIG. 6.

In step 610, encoded video data is acquired; for example, from a digital video camera or from a file containing video data. In step 620, a first set of data describing the pixel aspect ratio of the video data is created and/or stored. In step 630, a second set of data describing the specifications of a clean aperture of the video data is created and/or stored.

In step 640, based at least in part on the first and second sets of data, a third set of data is created and stored. According to an embodiment, the third set of data describes properties of each mode of a plurality of display modes for the video data. For example, the third set of data may comprise data that describes the dimensions would be for the video data when the video data is displayed in a particular mode. If a particular mode is based on cropping the video data with a pixel aspect ratio described by the first data to the clean aperture described by the second data, then scaling the cropped video data by the ratio between the pixel aspect ratio of the video data as described by the first set of data and an output pixel aspect ratio, then the ultimate dimensions of the display of the video data are created and stored as part of the third set of data.

According to an embodiment, this step may be performed for each mode of the plurality of modes, and allows for the application displaying the video data to simply read the third data to determine the dimensions and placement of the video data based on the chosen display mode.

In step 650, the first, second, and third sets of data are associated with the video data; for example, as metadata stored in the same file as the video data. The data may be associated with an entire file comprising the video data, one or more individual frames of the video data, or one or more tracks of the video data. In one embodiment, the first, second, and third sets of data are comprised of key-value pairs. In step 660, the first, second, and third sets of data are stored within the same file as the video data.

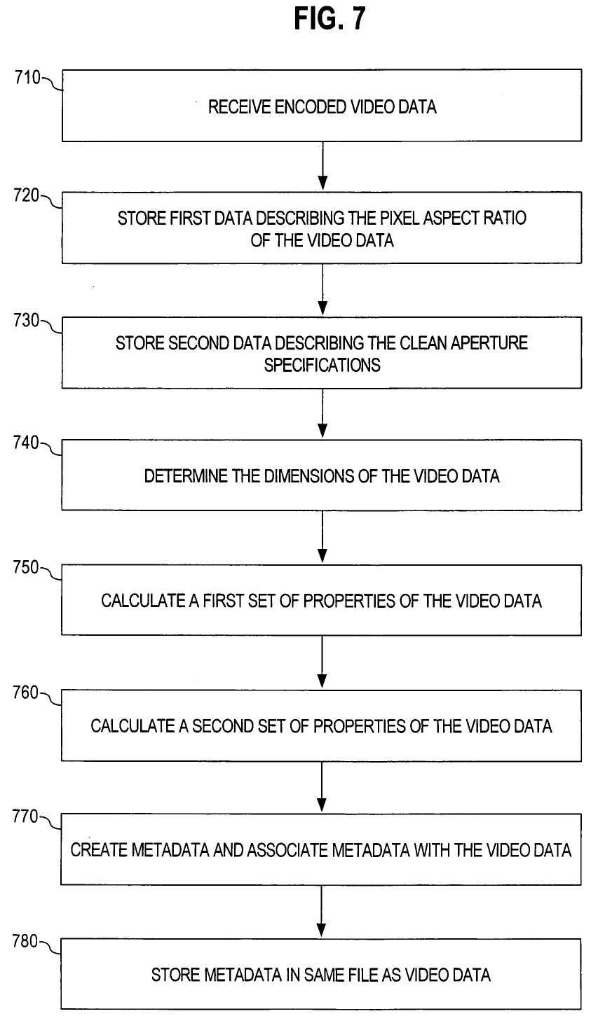

FIG. 7 is a flowchart illustrating the functional steps of displaying video data according to an embodiment of the invention. The particular sequence of steps illustrated in FIG. 7 is merely illustrative for purposes of providing a clear explanation. Other embodiments of the invention may perform various steps of FIG. 7 in parallel or in a different order than that depicted in FIG. 7.

In step 710, encoded video data is received. In step 720, a first set of data describing the pixel aspect ratio of the video data is associated with the video data; for example, as metadata. In step 730, a second set of data describing the specifications of a clean aperture of the video data is associated with the video data; for example, as metadata.

In step 740, the dimensions of the video data are determined. In an embodiment, the dimensions are measured in pixels, and the dimensions may be ascertained by analyzing the video data or provided with the video data, for example as metadata.

In step 750, a first set of properties of the video data is calculated based at least in part on analyzing the first and second sets of data. For example, the properties may include the dimensions of the video data compensating for scaling the video data by the ratio between the pixel aspect ratio of the video data and an output pixel aspect ratio of an intended display. According to an embodiment, the properties may include the dimensions of the video data compensating for scaling the video data by the ratio between the pixel aspect ratio of the video data to square pixels, for example a 1:1 ratio.

In step 760, a second set of properties of the video data is calculated based at least in part on analyzing the first and second sets of data. For example, the properties may include the dimensions of the video data compensating for cropping the video data to the clean aperture and scaling the cropped video data by the ratio between the pixel aspect ratio of the video data and an output pixel aspect ratio of an intended display. According to an embodiment, the properties may include the dimensions of the video data compensating for cropping the video data to the clean aperture and scaling the cropped video data by the ratio between the pixel aspect ratio of the cropped video data to square pixels, for example a 1:1 ratio.

In step 770, metadata is created and associated with the video data, where the metadata describes the dimensions of the video data, the first set of properties, and the second set of properties. According to an embodiment, the metadata may describe additional dimension data and/or sets of properties where the properties are based on data describing properties of the video data. In step 780, the metadata is stored within the same file as the video data.

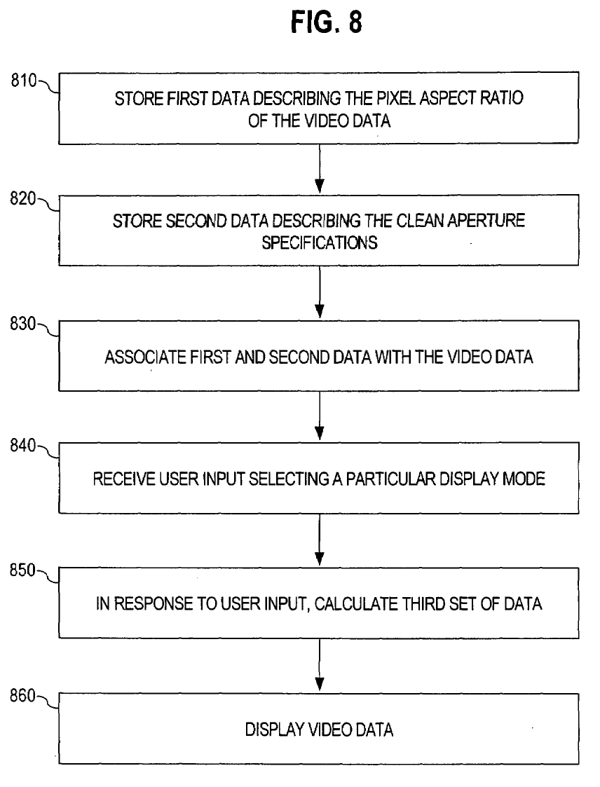

FIG. 8 is a flowchart illustrating the functional steps of displaying video data according to an embodiment of the invention. The particular sequence of steps illustrated in FIG. 8 is merely illustrative for purposes of providing a clear explanation. Other embodiments of the invention may perform various steps of FIG. 8 in parallel or in a different order than that depicted in FIG. 8.

In step 810, a first set of data describing the pixel aspect ratio of the video data is associated with the video data; for example, as metadata. In step 820, a second set of data describing the specifications of a clean aperture of the video data is created and/or stored; for example, as metadata. Because the clean aperture is the region of video that is clean of transition artifacts due to the encoding of the signal and is the region of video that is desired to be displayed to viewers, the parameters defining the outline of the clean aperture may be described as a boundary between “desired” and “undesired” data, as opposed to the data itself. The portion of the image outside the clean aperture is called the edge processing region and the video data in that location represents the “undesired” data. The specifications may include the dimensions of the clean aperture in pixels, such as 704 and 480, along with numbers indicating how the clean aperture is placed or positioned in the overall display. The numbers may be in the form of X and Y coordinates in pixels for one or more points along the clean aperture boundary, such as all four corners.

In step 830, the first and second sets of data describing the pixel aspect ratio of the video data and the data describing the clean aperture of the video data are associated with the video data; for example, as metadata stored in the same file as the video data. The data may be associated with an entire file comprising the video data, one or more individual frames of the video data, or one or more tracks of the video data. In one embodiment, the data describing the pixel aspect ratio of the video data and the data describing the clean aperture of the video data is comprised of key-value pairs.

In step 840, user input is received selecting a particular display mode of a plurality of display modes. According to an embodiment, each of the modes is associated with data describing at least the dimensions of the video based upon at least the first and second sets of data. For example, based on the pixel aspect ratio of a portion of video data, as well as the specifications of a clean aperture region of the video data, data may be calculated describing certain parameters of the display of the video data. For example, if the video data is cropped to the clean aperture and then scaled to the ratio between the pixel aspect ratio and the output pixel aspect ratio, data describing parameters of displaying the video data, such as the display dimensions and placement, may be associated with a “mode.”

In step 850, in response to the user input selecting the mode, a third set of data is calculated that describes placement of the display of the video data by applying a geometric transformation to the data associated with the selected mode. According to an embodiment, this may include scaling the display of the video data to half size, rotating the display of the video data, or otherwise transforming or altering the display of the video data.

In step 860, the video data is displayed. The display of the video data may be based on the third set of data.

### Implementing Mechanisms

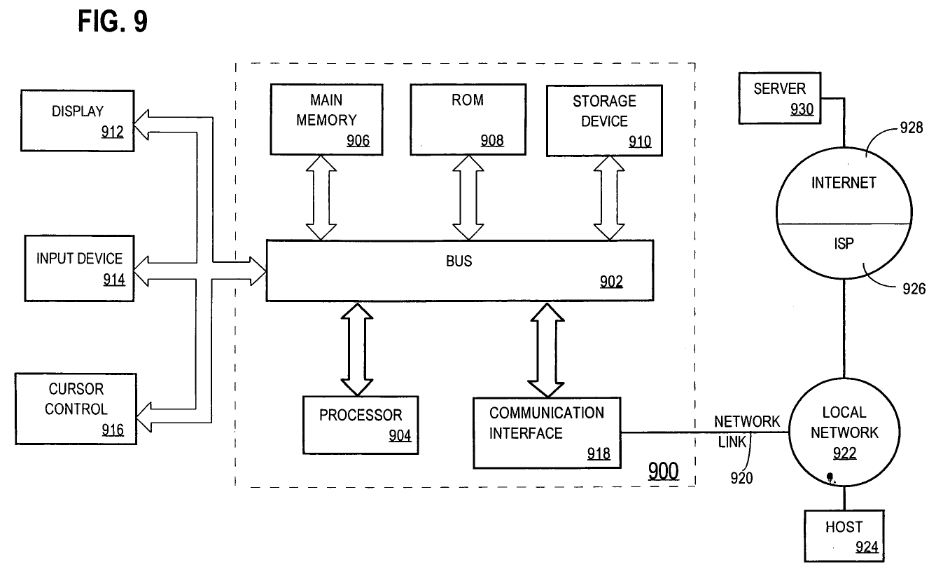

FIG. 9 is a block diagram that illustrates a computer system 900 upon which an embodiment of the invention may be implemented. Computer system 900 includes a bus 902 or other communication mechanism for communicating information, and a processor 904 coupled with bus 902 for processing information. Computer system 900 also includes a main memory 906, such as a random access memory (RAM) or other dynamic storage device, coupled to bus 902 for storing information and instructions to be executed by processor 904. Main memory 906 also may be used for storing temporary variables or other intermediate information during execution of instructions to be executed by processor 904. Computer system 900 further includes a read only memory (ROM) 908 or other static storage device coupled to bus 902 for storing static information and instructions for processor 904. A storage device 910, such as a magnetic disk or optical disk, is provided and coupled to bus 902 for storing information and instructions.

Computer system 900 may be coupled via bus 902 to a display 912, such as a cathode ray tube (CRT), for displaying information to a computer user. An input device 914, including alphanumeric and other keys, is coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912. This input device typically has two degrees of freedom in two axes, a first axis (e.g., x) and a second axis (e.g., y), that allows the device to specify positions in a plane.

The invention is related to the use of computer system 900 for implementing the techniques described herein. According to one embodiment of the invention, those techniques are performed by computer system 900 in response to processor 904 executing one or more sequences of one or more instructions contained in main memory 906. Such instructions may be read into main memory 906 from another machine-readable medium, such as storage device 910. Execution of the sequences of instructions contained in main memory 906 causes processor 904 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 900, various machine-readable media are involved, for example, in providing instructions to processor 904 for execution. Such a medium may take many forms, including but not limited to, non-volatile media, volatile media, and transmission media. Non-volatile media includes, for example, optical or magnetic disks, such as storage device 910. Volatile media includes dynamic memory, such as main memory 906. Transmission media includes coaxial cables, copper wire and fiber optics, including the wires that comprise bus 902. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 904 for execution. For example, the instructions may initially be carried on a magnetic disk of a remote computer. The remote computer can load the instructions into its dynamic memory and send the instructions over a telephone line using a modem. A modem local to computer system 900 can receive the data on the telephone line and use an infra-red transmitter to convert the data to an infra-red signal. An infra-red detector can receive the data carried in the infra-red signal and appropriate circuitry can place the data on bus 902. Bus 902 carries the data to main memory 906, from which processor 904 retrieves and executes the instructions. The instructions received by main memory 906 may optionally be stored on storage device 910 either before or after execution by processor 904.

Computer system 900 also includes a communication interface 918 coupled to bus 902. Communication interface 918 provides a two-way data communication coupling to a network link 920 that is connected to a local network 922. For example, communication interface 918 may be an integrated services digital network (ISDN) card or a modem to provide a data communication connection to a corresponding type of telephone line. As another example, communication interface 918 may be a local area network (LAN) card to provide a data communication connection to a compatible LAN. Wireless links may also be implemented. In any such implementation, communication interface 918 sends and receives electrical, electromagnetic or optical signals that carry digital data streams representing various types of information.

Network link 920 typically provides data communication through one or more networks to other data devices. For example, network link 920 may provide a connection through local network 922 to a host computer 924 or to data equipment operated by an Internet Service Provider (ISP) 926. ISP 926 in turn provides data communication services through the world wide packet data communication network now commonly referred to as the “Internet” 928. Local network 922 and Internet 928 both use electrical, electromagnetic or optical signals that carry digital data streams. The signals through the various networks and the signals on network link 920 and through communication interface 918, which carry the digital data to and from computer system 900, are exemplary forms of carrier waves transporting the information.

Computer system 900 can send messages and receive data, including program code, through the network(s), network link 920 and communication interface 918. In the Internet example, a server 930 might transmit a requested code for an application program through Internet 928, ISP 926, local network 922 and communication interface 918.

The received code may be executed by processor 904 as it is received, and/or stored in storage device 910, or other non-volatile storage for later execution. In this manner, computer system 900 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method for displaying video data, the computer-implemented method comprising:
storing first data describing a pixel aspect ratio of video data;
storing second data describing a boundary between desired data and undesired data within the video data;
associating the first and second data with the video data;
based on the first and second data, displaying the video data in a particular mode of a plurality of modes, wherein displaying the video data in said particular mode includes performing at least one of the following operations during display of the video data: (a) cropping the video data to said boundary to create cropped video data, and scaling the cropped video data by the ratio between the pixel aspect ratio of the cropped video data and an output pixel aspect ratio; (b) scaling the video data by the ratio between the pixel aspect ratio of the video data and the output pixel aspect ratio; and (c) using the original dimensions of the video data.

2. The method of claim 1 wherein the first data and the second data comprise key-value pairs.

3. The method of claim 1 wherein the step of associating the first and second data with the video data includes storing the first and second data as metadata within the same file as the video data.

4. The method of claim 1 wherein the second data describing a boundary between desired data and undesired data within the video data describes the placement and dimensions of a clean aperture associated with the video data.

5. The method of claim 1 wherein the step of performing at least one of the following operations during display of the video data does not permanently alter the video data.

6. The method of claim 1 wherein the undesired data comprises an edge processing region associated with the video data.

7. The method of claim 1 wherein the desired data comprises a clean aperture associated with the video data.

8. The method of claim 1 further comprising:
analyzing previously-created video data;
based on the analyzing previously-created video data:
creating first data describing a pixel aspect ratio of the previously-created video data;
creating second data describing a boundary between desired data and undesired data within the video data; and
wherein the steps of analyzing and creating the first and second data do not change properties of the previously-created video data.

9. The method of claim 1 further comprising:
receiving user input;
based on the user input, displaying the video data in one of the particular modes of the plurality of modes.

10. The method of claim 9, further comprising displaying a graphic user interface element.

11. The method of claim 1 further comprising:
storing third data describing properties of each mode of the plurality of modes;
associating the third data with the video data; and
storing the third data as metadata within the same file as the video data.

12. A computer-implemented method for displaying video data, the computer-implemented method comprising:
storing first data describing a pixel aspect ratio of video data;
storing second data describing the specification of a clean aperture associated with the video data;
based on the first data and second data, creating and storing third data describing properties of each mode of a plurality of video display modes for the video data wherein display of the video data in a particular mode of the plurality of modes is based on one of: (a) cropping the video data to the clean aperture to create cropped video data, and scaling the cropped video data by the ratio between the pixel aspect ratio of the cropped video data and an output pixel aspect ratio; (b) scaling the video data by the ratio between the pixel aspect ratio of the video data and the output pixel aspect ratio; and (c) using the original dimensions of the video data;
associating the first data, second data, and third data with the video data; and
storing the first data, second data, and third data within the same file as the video data.

13. A computer-readable medium carrying one or more sequences of instructions for displaying video data, wherein execution of the one or more sequences of instructions by one or more processors causes the one or more processors to perform the steps of:
receiving data comprising encoded video data;
associating first data describing the pixel aspect ratio of the video data with the video data;
associating second data describing the specification of a clean aperture associated with the video data;
determining the dimensions of the encoded video data;
based on analyzing the first and second data, calculating a first set of properties of the video data based on scaling the video data by the ratio between the pixel aspect ratio of the video data and the output pixel aspect ratio;
based on analyzing the first and second data, calculating a second set of properties of the video data based on cropping the video data to the clean aperture to create cropped video data, and scaling the cropped video data by the ratio between the pixel aspect ratio of the cropped video data and an output pixel aspect ratio;
creating and associating metadata with the video data, the metadata describing the dimensions of the encoded video data, the first set of properties, and the second set of properties; and
storing the metadata within the same file as the video data.

14. The computer-readable medium of claim 13, wherein the output pixel aspect ratio is 1:1.

15. A method comprising performing a machine-executed operation involving instructions, wherein the instructions are instructions which, when executed by one or more processors, cause the one or more processors to perform certain steps including:
storing first data describing a pixel aspect ratio of video data;
storing second data describing a boundary between desired data and undesired data within the video data;
associating the first and second data with the video data;
receiving user input selecting a particular mode of a plurality of modes, wherein each mode of the plurality of modes is associated with dimension values of the video data, the dimension values for each mode of the plurality of modes based at least in part on the first and second data;
in response to the user input, calculating third data describing placement of the display of the video data by applying a geometric transformation to the dimension values of the video data associated with the selected mode; and
based on the third data, displaying the video data;
wherein the machine-executed operation is at least one of (a) sending the instructions over transmission media, (b) receiving the instructions over transmission media, (c) storing the instructions onto a machine-readable storage medium, or (d) executing the instructions.

16. The method of claim 15 wherein the second data describing a boundary between desired data and undesired data within the video data describes the placement and dimensions of a clean aperture associated with the video data.

17. A computer-readable medium carrying one or more sequences of instructions which, when executed by one or more processors, causes the one or more processors to perform the method recited in claim 1.

18. A computer-readable medium carrying one or more sequences of instructions which, when executed by one or more processors, causes the one or more processors to perform the method recited in claim 2.

19. A computer-readable medium carrying one or more sequences of instructions which, when executed by one or more processors, causes the one or more processors to perform the method recited in claim 3.

20. A computer-readable medium carrying one or more sequences of instructions which, when executed by one or more processors, causes the one or more processors to perform the method recited in claim 4.

21. A computer-readable medium carrying one or more sequences of instructions which, when executed by one or more processors, causes the one or more processors to perform the method recited in claim 5.

22. A computer-readable medium carrying one or more sequences of instructions which, when executed by one or more processors, causes the one or more processors to perform the method recited in claim 6.

23. A computer-readable medium carrying one or more sequences of instructions which, when executed by one or more processors, causes the one or more processors to perform the method recited in claim 7.

24. A computer-readable medium carrying one or more sequences of instructions which, when executed by one or more processors, causes the one or more processors to perform the method recited in claim 8.

25. A computer-readable medium carrying one or more sequences of instructions which, when executed by one or more processors, causes the one or more processors to perform the method recited in claim 9.

26. A computer-readable medium carrying one or more sequences of instructions which, when executed by one or more processors, causes the one or more processors to perform the method recited in claim 10.

27. A computer-readable medium carrying one or more sequences of instructions which, when executed by one or more processors, causes the one or more processors to perform the method recited in claim 11.

28. A computer-readable medium carrying one or more sequences of instructions which, when executed by one or more processors, causes the one or more processors to perform the method recited in claim 12.
